(19) United States
(12) Patent Application Publication
(10) Pub. No.: US 2025/0158869 A1
(43) Pub. Date: May 15, 2025

(54) SPECTRAL SHAPING FOR DFT-S-OFDM

(71) Applicant: Samsung Electronics Co., Ltd., Suwon-si (KR)

(72) Inventors: Soheil Rostami, Carrollton, TX (US); Joonyoung Cho, Portland, OR (US)

(21) Appl. No.: 18/940,696

(22) Filed: Nov. 7, 2024

Related U.S. Application Data
(60) Provisional application No. 63/548,519, filed on Nov. 14, 2023.

(51) Int. Cl. H04L 27/26; H04W 72/231; H04W 72/51

(52) U.S. Cl. CPC H04L 27/2636; H04L 27/2614; H04W 72/231; H04W 72/51

(57) ABSTRACT

An apparatus includes a processor, and a transceiver operatively coupled to the processor. The transceiver is configured to split a set of modulated data symbols, based on a phase change between N consecutive modulated data symbols, to produce Q sets of data symbols, and generate, based on the Q sets of data symbols, Q sets of DFT spread data symbols. The transceiver is further configured to frequency domain spectrum shaping (FDSS) filter each set of the Q sets of DFT spread data symbols, via a different FDSS filter, to produce Q sets of FDSS filtered data symbols, and combine the Q sets of FDSS filtered data symbols. The transceiver is further configured to perform an inverse fast Fourier transform (IFFT) operation on the combined Q sets of FDSS filtered data symbols to produce a FDSS discrete Fourier transform-spread-orthogonal frequency division multiplexing (DFT-s-OFDM) signal, and transmit the FDSS-DFT-s-OFDM signal.

### CROSS-REFERENCE TO RELATED APPLICATION(S) AND CLAIM OF PRIORITY

This application claims priority under 35 U.S.C. § 119(e) to U.S. Provisional Patent Application No. 63/548,519 filed on Nov. 14, 2023. The above-identified provisional patent application is hereby incorporated by reference in its entirety.

### TECHNICAL FIELD

This disclosure relates generally to wireless networks. More specifically, this disclosure relates to spectral shaping for discrete Fourier transform-spread-orthogonal frequency division multiplexing (DFT-s-OFDM).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for spectral shaping for DFT-s-OFDM.

In one embodiment, an apparatus is provided. The apparatus includes a processor, and a transceiver operatively coupled to the processor. The transceiver is configured to split a set of modulated data symbols, based on a phase change between N consecutive modulated data symbols, to produce Q sets of data symbols, and generate, based on the Q sets of data symbols, Q sets of DFT spread data symbols. The transceiver is further configured to frequency domain spectrum shaping (FDSS) filter each set of the Q sets of DFT spread data symbols, via a different FDSS filter, to produce Q sets of FDSS filtered data symbols, and combine the Q sets of FDSS filtered data symbols. The transceiver is further configured to perform an inverse fast Fourier transform (IFFT) operation on the combined Q sets of FDSS filtered data symbols to produce a FDSS-discrete Fourier transform-spread-orthogonal frequency division multiplexing (DFT-s-OFDM) signal, and transmit the FDSS-DFT-s-OFDM signal.

In another embodiment, a method is provided. The method includes splitting a set of modulated data symbols, based on a phase change between N consecutive modulated data symbols, to produce Q sets of data symbols, and generating, based on the Q sets of data symbols, Q sets of DFT spread data symbols. The method further includes FDSS filtering each set of the Q sets of DFT spread data symbols, via a different FDSS filter, to produce Q sets of FDSS filtered data symbols, and combining the Q sets of FDSS filtered data symbols. The method further includes performing an IFFT operation on the combined Q sets of FDSS filtered data symbols to produce a FDSS-DFT-s-OFDM signal, and transmitting the FDSS-DFT-s-OFDM signal.

In yet another embodiment, a user equipment (UE) is provided. The UE includes a processor, and a transceiver operatively coupled to the processor. The transceiver is configured to receive a first message enabling a FDSS-DFT-s-OFDM capability of the UE, and receive a second message configuring the FDSS-DFT-s-OFDM capability for an uplink transmission. The UE is further configured to, in response to receiving the second message, split a set of modulated data symbols for the uplink transmission, based on a phase change between N consecutive modulated data symbols, to produce Q sets of data symbols, and generate, based on the Q sets of data symbols, Q sets of DFT spread data symbols. The transceiver is further configured to FDSS filter each set of the Q sets of DFT spread data symbols, via a different FDSS filter, to produce Q sets of FDSS filtered data symbols, and combine the Q sets of FDSS filtered data symbols. The transceiver is further configured to perform an IFFT operation on the combined Q sets of FDSS filtered data symbols to produce a FDSS-DFT-s-OFDM signal, and transmit the FDSS-DFT-s-OFDM signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example method for Double-FDSS-DFT-s-OFDM transmission according to embodiments of the present disclosure;

FIG. 5 a block diagram for example TX side signal processing according to embodiments of the present disclosure;

FIG. 6 illustrates a block diagram for another example of TX side signal processing according to embodiments of the present disclosure;

FIG. 7 illustrates a block diagram for example RX side signal processing according to embodiments of the present disclosure;

FIG. 8 illustrates an example normalized spectrum shape according to embodiments of the present disclosure;

FIG. 9 illustrates an example structure for “FDSSTypeIndexSet” according to embodiments of the present disclosure;

FIG. 10 illustrates an example method for signaling UE capability support according to embodiments of the present disclosure;

FIG. 11 illustrates an example method for FDSS configuration according to embodiments of the present disclosure;

FIG. 12 illustrates another example method for FDSS configuration according to embodiments of the present disclosure;

FIG. 13 an example method for MAC-CE FDSS configuration according to embodiments of the present disclosure;

FIG. 14 an example method for Double-Multi-FDSS configuration via DCI in PDCCH 1400 according to embodiments of the present disclosure;

FIG. 15 illustrates another example method for FDSS configuration according to embodiments of the present disclosure; and

FIG. 16 illustrates an example method for spectral shaping for DFT-s-OFDM according to embodiments of the present disclosure.

### DETAILED DESCRIPTION

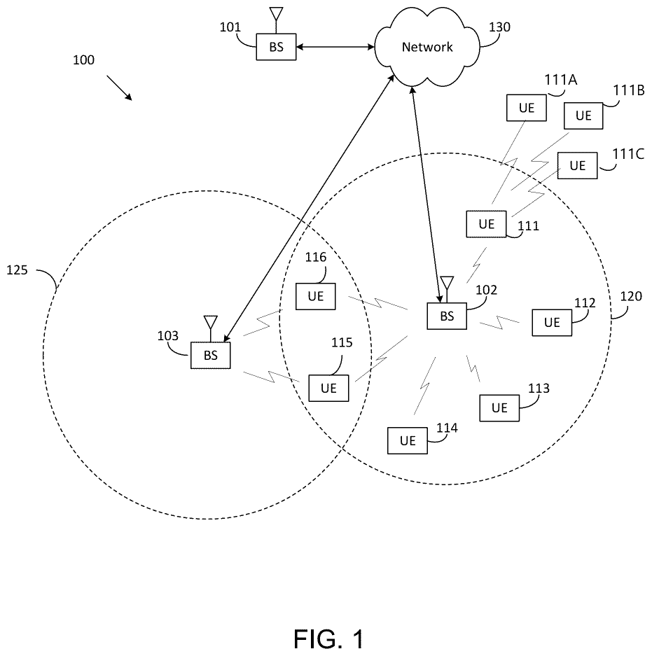

FIGS. 1 through 16, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for spectral shaping for DFT-s-OFDM. In certain embodiments, one or more of the gNBs 101-103 includes circuitry, programing, or a combination thereof, to support spectral shaping for DFT-s-OFDM in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

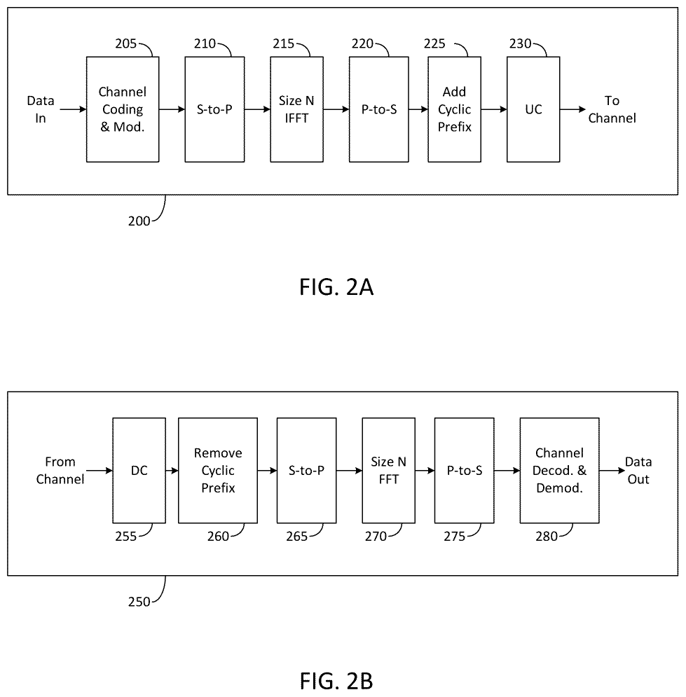

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support spectral shaping for DFT-s-OFDM as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

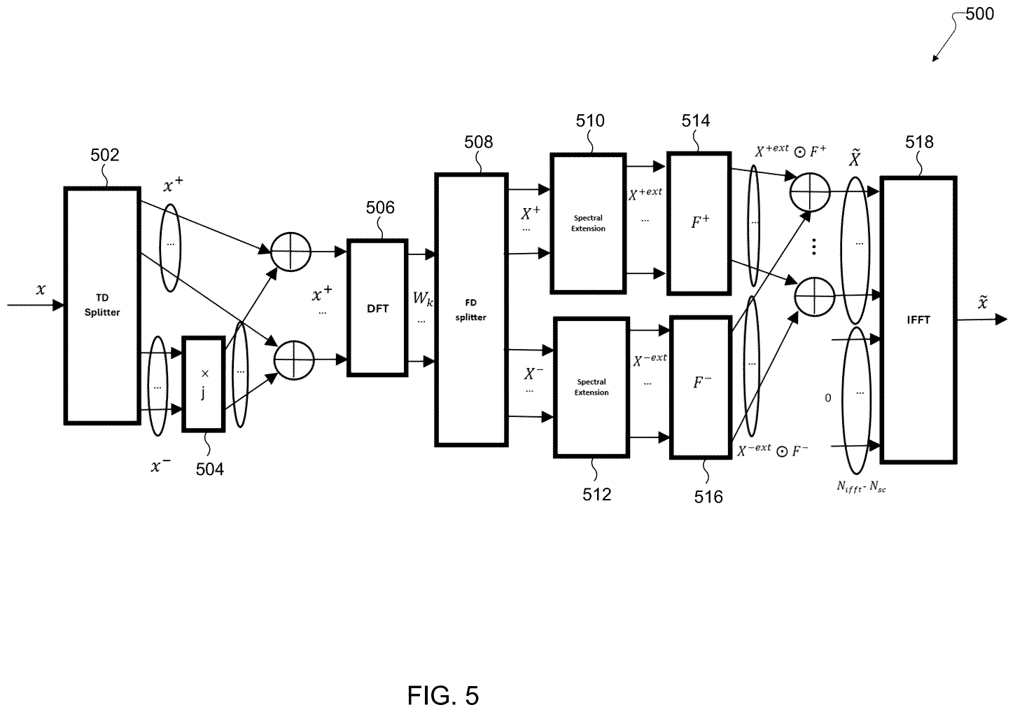

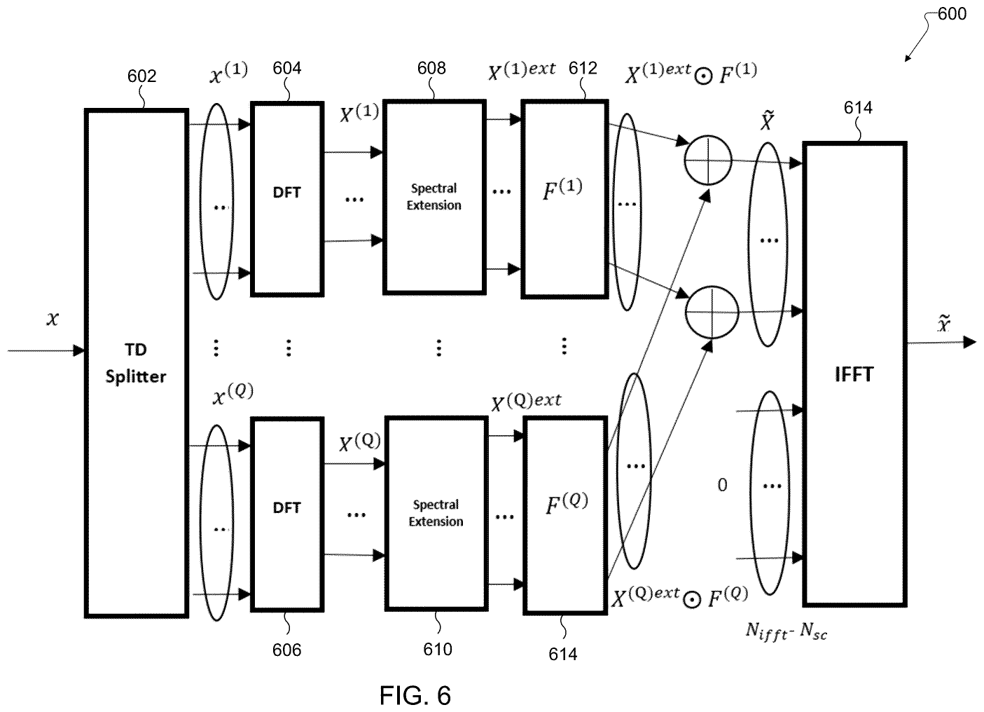

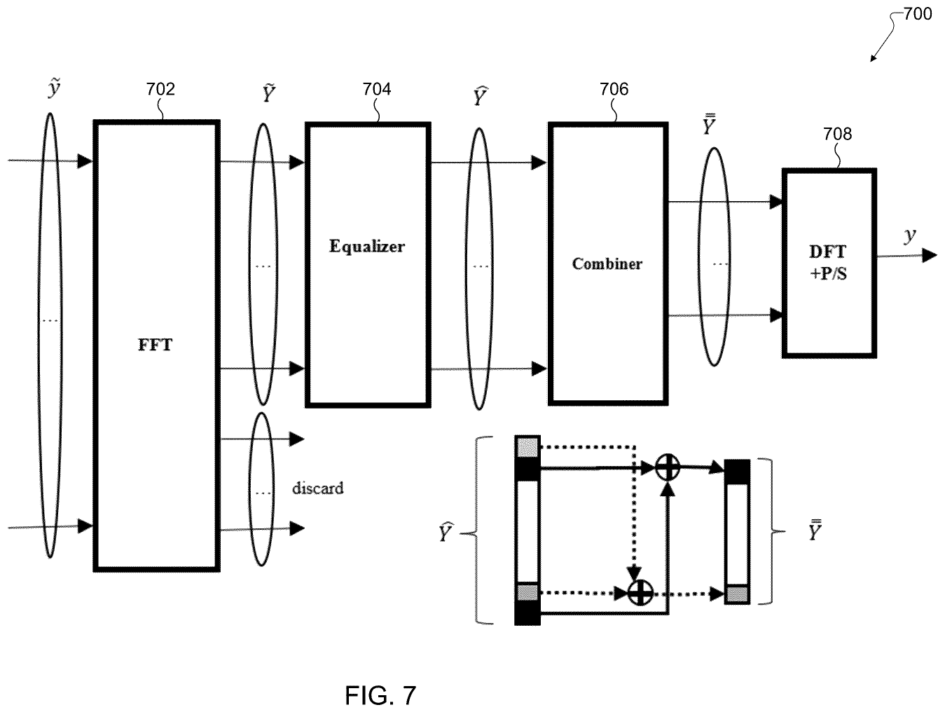

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the architectures of FIGS. 2A and 2B could be modified to include or be replaced by the architectures shown in FIG. 5, FIG. 6, and/or FIG. 7 as discussed in greater detail below.

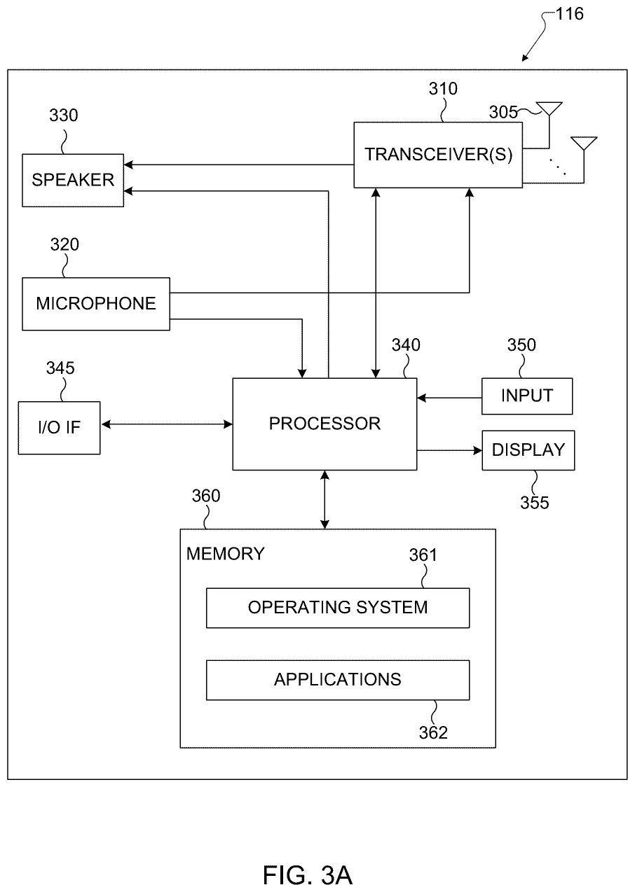

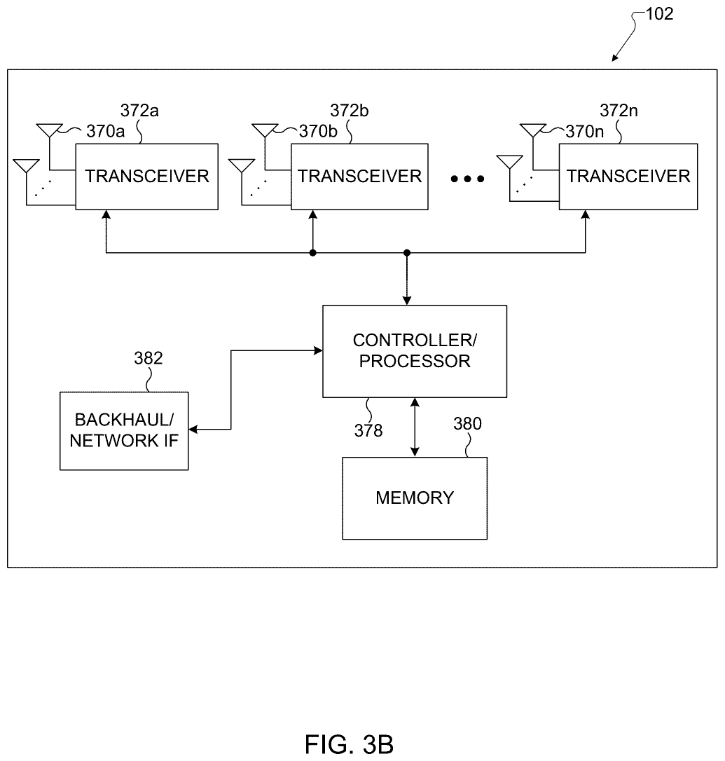

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for spectral shaping for DFT-s-OFDM as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. In some embodiments, the transceiver(s) 310 may include the architecture shown in FIG. 5, FIG. 6, and/or FIG. 7 as discussed in greater detail below. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support spectral shaping for DFT-s-OFDM as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. In another example, the transceivers 372a-372n may include the architecture shown in FIG. 5, FIG. 6, and/or FIG. 7 as discussed in greater detail below. Also, various components in FIG. 3B could be combined, further subdivided, or omitted and additional components could be added according to particular needs.

Discrete Fourier transform spreading OFDM (DFT-s-OFDM) has been adopted and commercialized as a key uplink waveform for 3GPP 4G/5G mobile communication systems, and is widely regarded as the baseline waveform of beyond 5G (B5G)/6G systems. In DFT-s-OFDM, the application of a DFT spreading operation prior to subcarrier mapping spreads the signal's energy across subcarriers, effectively achieves lower Peak-to-Average Power Ratio (PAPR) compared to OFDM, improves power amplifier efficiency, and reduces the risk of distortion. Improving the PAPR of DFT-s-OFDM may improve power amplifier efficiency, uplink coverage range and power consumption of UEs. For high-band (e.g., mmWave), a lower PAPR scheme for DFT-s-OFDM is more beneficial than for mid-band, as the UE maximum output power is lower for high-band, and power amplifier efficiency becomes even lower with the high-band.

There are different PAPR reduction techniques for DFT-s-OFDM, which may introduce signal distortion and sacrifice spectral efficiency. Among them, pulse shaping (also referred to as spectrum shaping) is known as a data-independent and low-complexity technique to reduce DFT-s-OFDM's PAPR at the cost of spectral extension (i.e., additional required subcarriers) and potentially higher symbol-error rate (SER).

Frequency Domain Spectrum Shaping (FDSS) and Time Domain Spectrum Shaping (TDSS) are two approaches for implementing spectrum shaping. However, for DFT-s-OFDM, FDSS is a more computationally-efficient and flexible approach. Furthermore, the power of the side lobes for FDSS is lower than for TDSS. Therefore, FDSS may be preferable to reduce DFT-s-OFDM's PAPR.

In the spectrum shaping approach, the pulse shaping filter is preceded by the spectral extension (SE) operation to reduce PAPR at the expense of the spectral extension. While frequency domain spectrum shaping (FDSS) for DFT-s-OFDM offers a low-PAPR option for uplink signaling, there is still room for PAPR improvement, especially in cases such as machine-type and device-to-device communications for a given spectral extension ratio. Moreover, spectral efficiency could be reduced by increasing the number of extended subcarriers and/or spectral efficiency degradation due to inter symbol interference introduced by the filter.

Pulse shaping filters can be defined using mathematical functions, such as cosine, exponential functions, parametric, and hyperbolic function. However, such pulse shapes may not achieve the best SER-PAPR trade-offs for given spectral extension.

The present disclosure provides various embodiments of spectral shaping schemes for PAPR reduction to enhance the performance of DFT-s-OFDM systems. In some embodiments, a spectrum shaping scheme generates an uplink signal by splitting the modulation data symbols into multiple data streams (the number of streams can be based on modulation order or other design factors), and by utilizing different pulse shapes, creates a joint output signal for the data streams with equal powers. In some embodiments, the spectrum shaping scheme can be adapted for transmission of the output signal using frequency division multiplexing or DFT-s-OFDM. In some embodiments, by adjusting the spectral extension, the spectrum shaping scheme can regulate the extent of PAPR improvement compared with conventional DFT-s-OFDM. Various embodiments described herein can be utilized and adapted to improve not only PAPR, but also spectral radiation or symbol error rate (or other requirements) when considering the nonlinearity of the power amplifier. Furthermore, by providing different pulse shapes for different streams, various embodiments provided can achieve and regulate desired signal characteristics such as symbol-error rate (SER) and PAPR trade-off.

The present disclosure also provides various embodiments of signaling between a UE and a BS for enabling/disabling and configuring/reconfiguring the Multi-FDSS filter and spectral extension ratio, dynamically and statically by introducing new information element fields to RRC and DCI as well as MAC-CE. The Multi-FDSS-DFT-s-OFDM embodiments described herein enable the synthesis of block-based single carrier waveforms over various spectral extension ratios and bandwidths (number of RBs). Various embodiments of signaling described herein enable application of any pre-defined and pre-specified pulse shape for an arbitrary number of scheduled resource blocks (RBs).

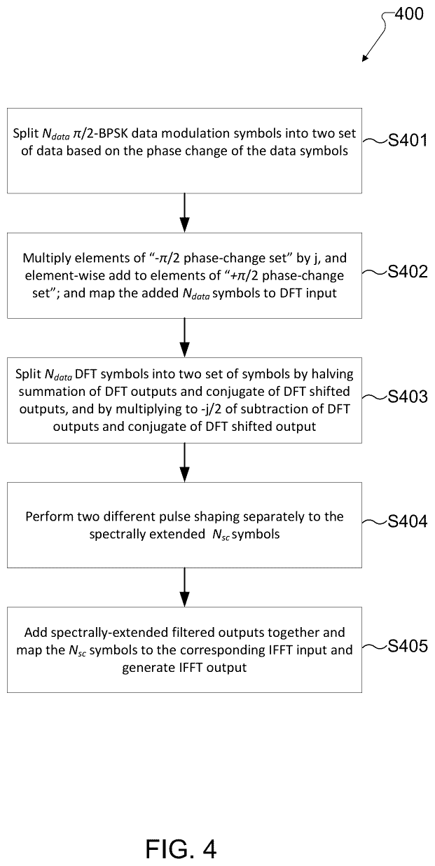

FIG. 4 illustrates an example method for Double-FDSS-DFT-s-OFDM transmission 400 according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a method for Double-FDSS-DFT-s-OFDM transmission could be used without departing from the scope of this disclosure.

In the example of FIG. 4, a transmitter (e.g., transceiver[s] 310 of UE 116) utilizes time-domain (TD) splitting, DFT spreading, frequency-domain (FD) splitting, frequency domain spectral shaping (FDSS) operations to generate π/2 BPSK-based signal, and leverages the architecture of DFT-S-OFDM to configure different FDSS filters. FIG. 4 illustrates an exemplary set of transmission operations to support Double-FDSS-DFT-s-OFDM. The complexity overhead of the transmission operations are minimal, as only additional multiplication is performed for pre DFT and post DFT.

In the example of FIG. 4, method 400 begins at operation S401. At operation S401, N_{data} π/2-BPSK data modulation symbols are split based on the phase change of two consecutive symbols into two sets of symbols: (1) “−π/2 phase-change set” and (2) “π/2 phase-change set”, each set of symbols with a length of N_{data}.

At operation S402, elements of the “−π/2 phase-change set” are multiplied by j (or equivalently constant +π/2 phase change) and element-wise added to elements of the “+π/2 phase-change set.” The N_{data} resultant symbols are then DFT spread.

At operation S403, the N_{data} DFT outputs are split into two set of frequency domain symbols, each with length of N_{data}, by halving the summation of the N_{data} DFT outputs and the conjugate of the shifted-version of the N_{data} DFT outputs, and by multiplying by −j/2 the subtraction of the N_{data} DFT outputs and the conjugate of the shifted version of the N_{data} DFT outputs.

At operation S404, two different FDSS filters are applied separately to the spectrally-extended versions of the two above mentioned sets of N_{data} frequency domain symbols. In one embodiment, the second FDSS filter is the first FDSS filter's conjugate reversed frequency.

At operation S405, spectrally-extended filtered outputs (each with length of N_{sc}=N_{data}+2Nₛₑ, where 2Nₛₑ is the number of extended subcarriers and N_{sc} is the total number of subcarriers) are added together and the IFFT operation with length of N_{ifft} is performed on the summation.

In the case where 2Nₛₑ=0 and FDSS equals a rectangular filter in the frequency domain, Double-FDSS-DFT-S-OFDM can become equivalent to 4G/5G DFT-s-OFDM. Additionally, in case the first FDSS and second FDSS are identical, Double-FDSS-DFT-S-OFDM can become equivalent to FDSS-DFT-S-OFDM as defined in 3GPP.

Although FIG. 4 illustrates one example method for Double-FDSS-DFT-s-OFDM transmission 400, various changes may be made to FIG. 4. For example, while shown as a series of steps, various steps in FIG. 4 could overlap, occur in parallel, occur in a different order, occur any number of times, be omitted, or replaced by other steps.

FIG. 5 illustrates a block diagram 500 for example TX side signal processing according to embodiments of the present disclosure. The embodiment of TX side signal processing of FIG. 5 is for illustration only. Different embodiments of TX side signal processing could be used without departing from the scope of this disclosure.

In the example of FIG. 5, block diagram 500 shows TX side signal processing to generate a Double-FDSS-DFT-S-OFDM signal. While not shown, it should be understood that a transmitter or transceiver employing the signal processing architecture shown in block diagram 500 may also include TX circuitry such as channel coding for data bits, cyclic prefix addition, digital-to-analog converter, analog filters, amplifiers, etc. similarly as shown in FIGS. 2A-3B, which are omitted for brevity.

At block 502, a modulated (π/2 BPSK) block of N_{data} symbols x=[x₀, xₘ . . . , x_{(N}_{_{data}}₋₁₎] are split based on the phase change of two consecutive symbols into two sets of symbols, a “+π/2 phase-change set”, referred to as x⁺ and “−π/2 phase-change set”, referred to as x⁻, each with a length of N_{data}, defined as follows:

$${x}^{+} = [ {x}_{0}^{+} , … {x}_{m}^{+} , … , {x}_{( {N}_{d a t a} - 1 )}^{+} ] , {x}_{m}^{+} = \frac{1}{π} ( \frac{π}{2} + Δ {θ}_{m} ) {x}_{m}$$

$$and$$

$${x}^{-} = [ {x}_{0}^{-} , … {x}_{m}^{-} , … , {x}_{( {N}_{d a t a} - 1 )}^{-} ] , {x}_{m}^{-} = \frac{1}{π} ( \frac{π}{2} - Δ {θ}_{m} ) {x}_{m}$$

$$∀ m ∈ \{ 0 , … , ( {N}_{d a t a - 1} ) \}$$

where Δθₘ is the phase change of two consecutive π/2 BPSK defined as, (∠x is the phase of x)

$$Δ {θ}_{m} = \{ \begin{matrix}∠ {x}_{( m + 1 )} - ∠ {x}_{m} , 0 \leq m < {N}_{d a t a} - 1 \\ ∠ {x}_{0} - ∠ {x}_{( {N}_{d a t a} - 1 )} , m = {N}_{d a t a} - 1\end{matrix} \qquad ( Equation 1 )$$

It can be shown that x⁺ and x⁻ have following properties, x=x⁺+x⁻ and 0=x⁺⊙x⁻ (⊙ is an element-wise multiplication).

At block 504, elements of the “−π/2 phase-change set”, x⁻ are multiplied by ×j and element-wise added to elements of the “+π/2 phase-change set”, x⁺. At block 506, the N_{data} resultant symbols (x⁺+jx⁻) are DFT spread as follows ( [symbol] { } is the DFT operation):

$${W}_{k} = ℱ {\{ {x}^{+} + j {x}^{-} \}}_{k} = \frac{1}{{N}_{d a t a}} {\sum }_{m = 0}^{{N}_{d a t a} - 1} ( {x}_{m}^{+} {e}^{- j ( k - 1 ) \frac{2 π m}{{N}_{data}}} + {x}_{m}^{-} {e}^{- j ( k - 1 ) \frac{2 π m}{{N}_{data}} {e}^{j \frac{π}{2}}} ) ,$$

$$∀ k ∈ \{ 1 , … , {N}_{data} \}$$

At block 508, a frequency domain (FD) splitter, separates and extracts the Fourier transform of x⁺ (refer to is as X⁺) and x⁻ (refer to is as X⁻) based on following equations:

$${X}_{k}^{+} = ℱ {\{ {x}^{+} \}}_{k} = \frac{1}{2} \times \{ \begin{matrix}{W}_{k} - {W}_{( - k + 1 + \frac{{N}_{d a t a}}{2} )}^{*} & 1 \leq k \leq {N}_{d a t a} / 2 \\ {W}_{k} - {W}_{( - k + 1 + \frac{3 {N}_{d a t a}}{2} )}^{*} & \frac{{N}_{d a t a}}{2} + 1 \leq k \leq {N}_{d a t a}\end{matrix} \}$$

$$and$$

$${X}_{k}^{-} = ℱ {\{ {x}^{-} \}}_{k} = - j / 2 \times \{ \begin{matrix}{W}_{k} - {W}_{( - k + 1 + \frac{{N}_{d a t a}}{2} )}^{*} & 1 \leq k \leq {N}_{d a t a} / 2 \\ {W}_{k} - {W}_{( - k + 1 + \frac{3 {N}_{d a t a}}{2} )}^{*} & \frac{{N}_{d a t a}}{2} + 1 \leq k \leq {N}_{d a t a}\end{matrix} \}$$

At blocks 510 and 512, the DFT symbol blocks Xₖ⁺ and Xₖ⁻ (∀k∈{1, . . . , N_{data}}) are separately circularly-extended to symbol blocks with length N_{sc} as:

$${X}^{+ ext} = [ {X}_{1}^{+ ext} , … , {X}_{{N}_{s c}}^{+ ext} ] = [ {X}_{{N}_{d a t a} - {N}_{s e} + 1}^{+} , … , {X}_{{N}_{d a t a}}^{+} , {X}_{1}^{+} , … , {X}_{{N}_{d a t a}}^{+} , {X}_{1}^{+} , … , {X}_{{N}_{s e}}^{+} ]$$

$$and$$

$${X}^{- ext} = [ {X}_{1}^{- ext} , … , {X}_{{N}_{s c}}^{- ext} ] = [ {X}_{{N}_{d a t a} - {N}_{s e} + 1}^{-} , … , {X}_{{N}_{d a t a}}^{-} , {X}_{1}^{-} , … , {X}_{{N}_{d a t a}}^{-} , {X}_{1}^{-} , … , {X}_{{N}_{s e}}^{-} ] ,$$

respectively. The spectral extension (SE) ratio is defined as

$$S E = \frac{2 {N}_{s e}}{{N}_{d a t a}} = \frac{2 {N}_{s e}}{{N}_{s c} - 2 {N}_{s e}} ,$$

ranging from 0 (no spectral extension) to higher values.

At blocks 514 and 516, the symmetrically extended DFT symbol blocks X^{+ext} and X^{-ext} with length N_{sc} are filtered via FDSS filters with tap values of F⁺=[F₁⁺, . . . , Fₖ⁺, . . . , F_{N}_{_{sc}}⁺] and F⁻=[F₁⁻, . . . , Fₖ⁻, . . . , F_{N}_{_{sc}}⁻], respectively (where Fₖ⁺ and Fₖ⁻ are frequency domain filter taps of F⁺ and F⁻, corresponding to k^{th} subcarrier (∀k∈{1, . . . , N_{sc}}), respectively). In some embodiments, the filtering can be achieved by a computationally-efficient operation of element wise multiplication and summation as follows:

$$\tilde{X} = {X}^{+ ext} ⊙ {F}^{+} + {X}^{- ext} ⊙ {F}^{-} .$$

At block 518, the filtered symbol block \tilde{X} is mapped to the scheduled N_{sc} subcarriers and is converted into the OFDM symbol in time domain by IFFT with a length of N_{ifft} as \tilde{x}=[\tilde{x}₁, . . . , \tilde{x}_{N}_{_{ifft}}]. With some mathematical manipulation, it can be shown that the output of the IFFT (assumed that first N_{sc} input of N_{ifft}-IFFT are utilized for sub-carriers) can be modeled as a summation or superposition of two single carrier transmission as follows (T_{d} is the symbol interval and is calculated as T_{d}=N_{ifft}/N_{data}),

$$\tilde{x} ( n ) = \frac{1}{{N}_{d a t a}} {\sum }_{m = 0}^{{N}_{d a t a} - 1} {x}_{m}^{+} \cdot {f}^{+} ( n - m {T}_{d} ) + \frac{1}{{N}_{d a t a}} {\sum }_{m = 0}^{{N}_{d a t a} - 1} {x}_{m}^{-} \cdot {f}^{-} ( n - m {T}_{d} )$$

$$where {f}^{+} ( n ) = {\sum }_{k = 1}^{{N}_{sc}} {F}_{k}^{+} {e}^{j n \frac{2 π ( k - 1 )}{{N}_{ifft}}} and {f}^{-} ( n ) = {\sum }_{k = 1}^{{N}_{sc}} {F}_{k}^{-} {e}^{j n \frac{2 π ( k - 1 )}{{N}_{ifft}}} .$$

Although FIG. 5 illustrates a block diagram 500 for example TX side signal processing, various changes may be made to FIG. 5. For example, additional processing steps, etc. could be added to block diagram 500 according to particular needs.

FIG. 6 illustrates a block diagram 600 for another example of TX side signal processing according to embodiments of the present disclosure. The embodiment of TX side signal processing of FIG. 6 is for illustration only. Different embodiments of TX side signal processing could be used without departing from the scope of this disclosure.

In the example of FIG. 6, block diagram 600 shows TX side signal processing to generate a Multi-FDSS-DFT-s-OFDM signal for higher order quadrature amplitude modulation (e.g., QPSK) or π/2 BPSK. While not shown, it should be understood that a transmitter or transceiver employing the signal processing architecture shown in block diagram 600 may also include TX circuitry such as channel coding for data bits, cyclic prefix addition, digital-to-analog converter, analog filters, amplifiers, etc. similarly as shown in FIGS. 2A-3B, which are omitted for brevity.

At block 602, a modulated block of N_{data} symbols x=[x₀, . . . xₘ, . . . , x_{(N}_{_{data}}₋₁₎] is split to multiple streams based on different rules. In some embodiments, a time domain (TD) splitter generates Q different streams based on the phase change of two consecutive symbols. In some other embodiments, a TD splitter may separate input data modulation symbols based on more than two consecutive symbols phase change. The set of phase changes for a given modulation scheme can be modelled as A=[A₁, . . . , A_{q}, . . . , A_{Q}], where none of two elements of the set refers to the same angle. In the case of π/2 BPSK,

$$A = [ + \frac{π}{2} , - \frac{π}{2} ]$$

and Q=2. In the case of QPSK,

$$A = [ 0 , + \frac{π}{2} , - \frac{π}{2} , + π ]$$

and Q=4. The q^{th} stream can be modelled as x^{(q)}=x₀^{(q)}, . . . xₘ^{(q)}, . . . , x_{(N}_{_{data}}₋₁₎(q), where:

$${x}_{m}^{( q )} = \{ \begin{matrix}{x}_{m} , & {Δθ}_{m} = {A}_{q} \\ 0 , & {Δθ}_{m} \neq {A}_{q}\end{matrix}$$

where Δθₘ is the phase change of two consecutive symbols defined in Equation 1. It can be shown that the streams satisfy following equations, x=Σ_{q=1}^{q=Q}x^{(q)} and 0=Π_{q=1}^{q=Q}x^{(q)} (where Π is referring to an element-wise multiplication).

At blocks 604 and 606, each stream is DFT spread separately as follows ( [symbol] { } is DFT operation):

$${X}_{k}^{( q )} = ℱ {\{ {x}^{( q )} \}}_{k} = \frac{1}{{N}_{data}} {\sum }_{m = 0}^{{N}_{data} - 1} {e}^{- j k \frac{2 π m}{{N}_{data}}}$$

At blocks 608 and 610, the DFT symbol blocks X^{(q)} are separately spectrally-extended to symbol blocks with length N_{sc} as,

$${X}^{( q ) ext} = [ {X}_{1}^{( q ) ext} , … , {X}_{{N}_{s c}}^{( q ) ext} ] = [ {X}_{{N}_{data} - {N}_{s e} + 1}^{( q )} , … , {X}_{{N}_{data}}^{( q )} , {X}_{1}^{( q )} , … , {X}_{{N}_{d a t a}}^{( q )} , {X}_{1}^{( q )} , … , {X}_{{N}_{s e}}^{( q )} ] .$$

At blocks 612 and 614, the spectrally-extended DFT symbol blocks X^{(q)ext} with length N_{sc} are filtered by FDSS filters with tap values of F^{(q)}=[F₁^{(q)}, . . . , Fₖ^{(q)}, . . . , F_{N}_{_{sc}}^{(q)}] (where Fₖ^{(q)} are frequency domain filter taps of F^{(q)}, corresponding to the k^{th} subcarrier). In some embodiments, the filtering can be achieved by a computationally-efficient operation of element wise multiplication and summation as follows:

$$\tilde{X} = {\sum }_{q = 1}^{q = Q} {F}^{( q )} ⊙ {X}^{( q ) ext}$$

At block 614, the filtered symbol block \tilde{X} is mapped to the scheduled N_{sc} subcarriers and is converted into the OFDM symbol in the time domain by IFFT with a length of N_{ifft} as \tilde{x}=[\tilde{x}₁, . . . , \tilde{x}N_{ifft}]. With some mathematical manipulation, it can be shown that the output of the IFFT can be modeled as a summation/superposition of Q single carrier transmissions as follows (T_{d} is the symbol interval and is calculated as T_{d}=N_{ifft}/N_{data}),

$$\tilde{x} ( n ) = \frac{1}{{N}_{d a t a}} {\sum }_{q = 1}^{q = Q} {\sum }_{m = 0}^{{N}_{data} - 1} {x}_{m}^{( q )} \cdot {f}^{( q )} ( n - m {T}_{d} )$$

$$where {f}^{( q )} ( n ) = {\sum }_{k = 1}^{{N}_{s c}} {F}_{k}^{( q )} {e}^{j n \frac{2 π ( k - 1 )}{{N}_{ifft}}} .$$

Although FIG. 6 illustrates a block diagram 600 for example TX side signal processing, various changes may be made to FIG. 6. For example, additional processing steps, etc. could be added to block diagram 600 according to particular needs.

The embodiments described above for Double/Multi-FDSS-DFT-s-OFDM could be adapted and extended to higher order modulation (e.g., QPSK or 16 QAM, etc.) schemes. Furthermore, numerical or machine learning based approaches could be applied to optimize values of Fₖ^{(q)} (∀q∈{1, . . . , Q}) to achieve desired design requirements (e.g., PAPR-SER trade-off).

In some embodiments, the complexity of Multi-FDSS-DFT-s-OFDM could be reduced by reducing the number of DFT blocks from Q to 1 with some pre- and/or post-DFT operations. Such reduced complexity may be utilized in Double-FDSS-DFT-s-OFDM (F⁽¹⁾=F⁺ and F⁽²⁾=F⁻), where instead of using two DFTs with the size of N_{data} (Q=2, FIG. 6), a single DFT with a size of N_{data} with some additional pre- and post-DFT processing (FIG. 5) is applied.

FIG. 7 illustrates a block diagram 700 for example RX side signal processing according to embodiments of the present disclosure. The embodiment of RX side signal processing of FIG. 7 is for illustration only. Different embodiments of RX side signal processing could be used without departing from the scope of this disclosure.

In the example of FIG. 7, block diagram 700 shows RX side signal processing for demodulating an FDSS-DFT-S-OFDM signal such as the signals generated by the architectures illustrated in FIG. 5 and FIG. 6. While not shown, it should be understood that a receiver or transceiver employing the signal processing architecture shown in block diagram 700 also may include RX circuitry such as channel decoding for data bits, removing cyclic prefix addition, analog-to-digital converter, analog filters, amplifiers, etc. similarly as shown in FIGS. 2A-3B, which are omitted for brevity.

In the Example of FIG. 7, at block 702 the receiving device (e.g., a BS) (after removing cyclic prefix) obtains samples with a length N_{ifft} as \tilde{y}=[\tilde{y}₁, . . . , \tilde{y}_{N}_{_{fft}}], then converts the samples into the symbol block in frequency domain and extracts corresponding number of subcarriers with length N_{sc}, i.e., Ý=[\tilde{Y}₁, . . . , \tilde{Y}N_{sc}].

At block 704, the receiving device equalizes the symbols on scheduled subcarriers with element wise multiplication,

$$\hat{Y} = \tilde{Y} ⊙ \frac{{F}^{*}}{{\vert \tilde{F} \vert}^{2}} ,$$

where F* could be defined as conjugate of transmit filter F and \tilde{F}=[F_{N}_{ₛₑ}₊₁+F_{N}_{_{sc}}_{-N}_{ₛₑ}₊₁, . . . , F_{2N}_{ₛₑ}+F_{N}_{_{sc}}, F_{2N}_{_{Se}}₊₁, F_{N}_{_{sc}}_{-2N}_{_{Se}}, F_{N}_{_{sc}}_{-2N}_{ₛₑ}₊₁+F₁, . . . , F_{N}_{_{sc}}_{-N}_{ₛₑ}+F_{N}_{ₛₑ}]. In some embodiments, F* can be assumed as an all-one or rectangular filter.

At block 706, after equalization, to obtain the DFT symbol block with the length N_{data}, the corresponding symbols on the spectrum extension and data subcarriers are combined as follows:

$$\overline{\overline{Y}} = [ {\hat{Y}}_{{N}_{s e} + 1} + {\hat{Y}}_{{N}_{s c} - {N}_{s e} + 1} , … , {\hat{Y}}_{2 {N}_{s e}} + {\hat{Y}}_{{N}_{s c}} , {\hat{Y}}_{2 {N}_{s e} + 1} , … , {\hat{Y}}_{{N}_{s c} - 2 {N}_{se}} , {\hat{Y}}_{{N}_{s c} - 2 {N}_{s e} + 1} + {\hat{Y}}_{1} , … , {\hat{Y}}_{{N}_{s c} - {N}_{s e}} + {\hat{Y}}_{{N}_{s e}} ]$$

At block 708, the DFT symbol block with a length N_{data}, Y̅ is converted into the modulated symbol block in the time domain with IDFT length N_{data}, y=[y₁, . . . , N_{data}].

In some embodiments, the receiver architecture of FIG. 7 could be implemented specifically for Double/Multi-FDSS-DFT-s-OFDM to further improve its symbol-error rate performance. There is no additional complexity overhead in the RX side compared to conventional FDSS based DFT-s-OFDM, although RX performance may be improved further by utilizing more complex receiver architectures.

Although FIG. 7 illustrates a block diagram 700 for example RX side signal processing, various changes may be made to FIG. 7. For example, additional processing steps, etc. could be added to block diagram 700 according to particular needs.

In some embodiments, FDSS filters (F^{(q)}∀q∈{1, . . . , Q}) for Double/Multi-FDSS-DFT-s-OFDM can be configured by a base-station (BS) for a given spectral extension ratio. In some embodiments, the filter taps could provide consistent PAPR improvement for a given spectral extension ratio, regardless of the number of resource blocks. In some embodiments, the FDSS filter parameters can be specified (but not limited) according to a standard based on one of the following:
Closed-Form equations
Polynomial coefficients
Frequency domain tap values of the FDSS
Time domain tap values of the FDSS

Existing pulse shaping filters have been defined using well-established mathematical functions, such as cosine functions, exponential functions, or hyperbolic functions. However, conventional pulse shapes may not achieve the best SER-PAPR trade-offs for a given spectral extension.

Inspired by the 0 dB PAPR of minimum shift keying (MSK), which generates a perfect constant envelope signal, various embodiments of FDSS filters (F⁽¹⁾=F⁺ and F⁽²⁾=F⁻) for Double-FDSS-DFT-s-OFDM are provided for any spectral extension ratio. In the example filters, each data symbol is modulated by gradually changing the phase of the signal from the data symbol's constellation phase (∠xₘ) towards the next data symbol's constellation phase (∠xₘ₊₁), over the symbol interval of T_{d}. In such examples, both FDSS filters (F⁺ and F⁻) depend on each other as follows

$${F}_{k}^{( - )} = \{ \begin{matrix}{( {F}_{( - k + \frac{{N}_{sc}}{2} + 1 )}^{( + )} )}^{*} , & 1 \leq k \leq {N}_{sc} / 2 \\ {( {F}_{( - k + \frac{3 {N}_{sc}}{2} + 1 )}^{( + )} )}^{*} , & \frac{{N}_{sc}}{2} + 1 \leq k \leq {N}_{sc}\end{matrix} \qquad ( Equation 2 )$$

or equivalently in the time domain, both filters have the reversed impulse response f⁺(n)=f^{-n*}.

For example, in some embodiments, for Δθₘ=π/2, xₘ(=xₘ⁺) is filtered via f⁺(n), where its phase is changing from 0 to +π/2 during the m^{th} symbol time interval, corresponding to t=mT_{d} to t=(m+1)T_{d} (a similar process can be performed for Δθₘ=−π/2). In some embodiments, f⁺(n) can be defined as a filtered version of an M-tap-pulse

$${o}^{+} ( n ) = [ {e}^{j {∅}^{( + )} ( 0 )} , {e}^{j {∅}^{( + )} ( 1 )} , … , {e}^{j {∅}^{( + )} ( n )} , … , {e}^{j {∅}^{( + )} ( M - 1 )} ]$$

where its phase changes gradually from 0 to +π/2 during a symbol time interval T_{d}. A frequency domain representation of zero-padded o⁺(n) is,

$$ℱ {\{ {o}^{+} \}}_{k} = {e}^{j {∅}^{( + )} ( 0 )} + {\sum }_{n = 1}^{n = M - 1} {e}^{j {∅}^{( + )} ( n )} {e}^{- j \frac{2 π n ( k - 1 )}{M {N}_{data}}} , ∀ k ∈ \{ 1 , … , {MN}_{data} \}$$

And Fₖ⁺ can be expressed as a filtered version of [symbol] {o⁺}ₖ,

$${F}_{k}^{+} = \{ \begin{matrix}ℱ {\{ {o}^{+} \}}_{k} , & 1 \leq k \leq \frac{{N}_{sc}}{2} \\ ℱ {\{ {o}^{+} \}}_{k} , & {MN}_{data} - {N}_{sc} / 2 + 1 \leq k \leq {MN}_{data}\end{matrix} \qquad ( Equation 3 )$$

based on Equation 2, one can obtain Fₖ⁻.

In some embodiments, ∅⁽⁺⁾(n) or ∅⁽⁻⁾(n) ∀n∈{0, . . . , M−1} (M itself as well) or both Fₖ⁺ and Fₖ⁻ can be selected to achieve a desired SER-PAPR trade-off. In some embodiments, by leveraging machine learning or numerical approaches, ∅⁽⁺⁾(n) or ∅⁽⁻⁾(n) or Fₖ⁺ and Fₖ⁻ can be optimized and calculated.

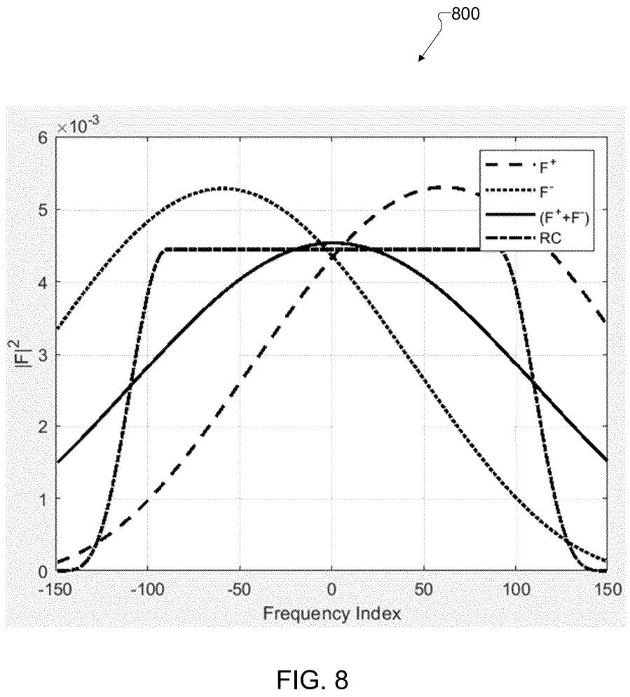

FIG. 8 illustrates an example normalized spectrum shape 800 according to embodiments of the present disclosure. The embodiment of normalized spectrum shape of FIG. 8 is for illustration only. Different embodiments of a normalized spectrum shape could be used without departing from the scope of this disclosure.

In the example of FIG. 8,

$${∅}^{( + )} ( n ) = \frac{π}{2 M} n ,$$

M=4 and ∀n∈{0, . . . , 3}, the absolute value of Fₖ⁺, Fₖ⁻ and (Fₖ⁺+Fₖ⁻) are plotted for N_{sc}=300 and N_{data}=240. (Fₖ⁺+Fₖ⁻) represent the overall average frequency shape of the Double-FDSS-DFT-s-OFDM scheme, if the data symbols are drawn equiprobable.

The PAPR gain (at complementary cumulative distribution function [CCDF] of 10⁻³) and SNR loss (due to introduction of inter symbol interference by the FDSSs at SER loss of 10⁻²) of

$$( {∅}^{( + )} ( n ) = \frac{π}{2 M} n ,$$

M=4 and ∀n∈{0, . . . , 3}) are compared to a baseline root-raised-cosine filter. Table 1 provides the PAPR gain and SNR loss of Double-FDSS-DFT-s-OFDM for different spectral extension ratios under π/2 BPSK modulations when 240 data symbols are utilized. As it can be seen, the example Double-FDSS-DFT-s-OFDM provides over 2.4 PAPR gain compared to root-raised-cosine filter with 0.25 dB loss in SNR compared to root-raised-cosine filter when 5% spectral extension is applied.

TABLE 1
Double-FDSS-DFT-s-OFDM π/2 BPSK
performance for different SE ratios
compared to root-raised-cosine filter

| | | | | SNR | PAPR |
|---|---|---|---|---|---|
| | | | SE | loss at | gain at |
| Example | N_{data} | N_{sc} | (%) | SER = 10⁻² | CCDF = 10⁻³ |
| 1 | 240 | 240 | 0% | 0.3 | 2.72 dB |
| 2 | 240 | 252 | 5% | 0.26 | 2.41 dB |
| 3 | 240 | 264 | 10% | 0.25 | 2.1 dB |
| 4 | 240 | 276 | 15% | 0.25 | 1.73 dB |
| 5 | 240 | 288 | 20% | 0.22 | 1.6 dB |
| 6 | 240 | 300 | 25% | 0.25 dB | 1.5 dB |

Although FIG. 8 illustrates an example normalized spectrum shape 800, various changes may be made to FIG. 8. For example, FIG. 8 could plot a normalized spectrum shape for a different value of M, and the shapes could change correspondingly.

In some embodiments, for FDSS, each QPSK data symbol can be modulated by gradually changing the phase of the signal from the data symbol's constellation phase towards the next data symbol's constellation phase, over the symbol interval of T_{d}. For example,

$$A = [ 0 , + \frac{π}{2} , - \frac{π}{2} , + π ]$$

and hence four (Q=4) different FDSSs could be defined. In such an embodiment, Fₖ⁽¹⁾=1, ∀k∈{1, . . . , N_{sc}} corresponding to no phase change A₁=0. In some embodiments, for a corresponding phase change of A₂=π/2 and A₃=−π/2, the F⁽²⁾=F⁽⁺⁾ and F⁽³⁾=F⁽⁻⁾ could be defined the same as Equation 2 and equation 3 (in the case of π/2 BPSK) with

$${∅}^{( 2 )} ( n ) = \frac{π}{2 M} n ,$$

(∅⁽³⁾(n) can be calculated using Equation 2). For the corresponding phase change of A₄=π,

$${∅}^{( 4 )} ( n ) = \frac{π}{M} n$$

could be defined by gradually changing the phase of the signal for π radians during symbol time.

In some embodiments, a standard may define and specify the closed form equations for Fₖ^{(q)}, ∀q∈{1, . . . , Q} for a given modulation, regardless of spectral extension ratio. For example, the closed form equations given above for π/2 BPSK (F⁽¹⁾=F⁺, F⁽²⁾=F⁻) and QPSK (F⁽¹⁾, F⁽²⁾, F⁽³⁾, F⁽⁴⁾). In some embodiments, a standard may specify ∅ₖ^{(q)}, ∀q∈{1, . . . , Q} that defines the phase change per each stream, from which the corresponding F^{(q)} can be obtained.

In some embodiments, FDSS filter values Fₖ^{(q)}, ∀q∈{1, . . . , Q} can be defined and modeled as coefficients using polynomial approximations. For example, a standard may specify Q sets of D^{th} order polynomial coefficients, a_{d}^{(q)} (d=0, . . . , D) for a given spectral extension ratio. Therefore, UE or BS can calculate Fₖ^{(q)} for ∀k∈{1, . . . , N_{sc}} as follows,

$${F}_{k}^{+} = {\sum }_{d = 0 , … , D} {a}_{d}^{+} {s ( k - 1 )}^{d} ,$$

where s(0), . . . , s(N_{sc}−1) is the support vector representing equally spaced values with a step-size of

$$\frac{2}{{N}_{sc} - 1}$$

over the interval [−1, +1], and the b^{th} element (b=0, . . . , N_{sc}−1) of support vector can be calculated as,

$$s ( b ) = - 1 + \frac{2 b}{{N}_{sc} - 1}$$

With this approach, Q sets of D+1 polynomial coefficients can define Fₖ^{(q)} ∀q∈{1, . . . , Q} and ∀k∈{1, . . . , N_{sc}}, regardless of N_{sc}. In some embodiments, the coefficients may change based on the spectral extension ratio.

In some embodiments, it is assumed that Fₖ^{(q)ref}∀k∈{1, . . . , N_{sc}_{_{ref}}} are FDSS taps for the q^{th} stream corresponding to a specific set of reference FDSS subcarriers. In some embodiments, such reference tap values for a given spectral extension ratio can be specified in a standard. In some embodiments, resampling of reference taps can be performed (e.g., by a UE or BS) to covert N_{sc}_{_{ref}} taps to complete the FDSS with N_{sc} taps.

In some embodiments, N_{sc}_{_{ref}} parameters can be specified in a standard for a smallest subcarrier spacing (e.g., 15 KHz) and maximum number of subcarriers (e.g., N_{sc}_{_{ref}}=3300). This can help with finer FDSS values for different subcarrier numbers and spacing. In some embodiments, the reference number of subcarriers can be selected for an intermediate number of subcarriers (e.g., N_{sc}_{_{ref}}=384 subcarriers). Because of the intermediate number of subcarriers, the memory for storying the reference FDSS values (N_{sc}_{_{ref}}) is lower than for example N_{sc}_{_{ref}}=3300 without much degradation in performance.

In some embodiments, the ratio

$$\frac{{N}_{sc}}{{N}_{{sc}_{ref}}}$$

can be simplified to a rational number L/G, i.e.

$$\frac{{N}_{sc}}{{N}_{{sc}_{ref}}} = \frac{L}{G} .$$

In some embodiments, this can be accomplished by L-fold up-sampling, followed by low-pass filtering and then G-fold down sampling.

In some embodiments, for L-fold up-sampling, Wₖ^{(q)} for k=1, . . . , N_{sc}_{_{ref}} and q=1, . . . , Q are up-sampled parameters of reference taps (Fₖ^{(q)ref}) and are calculated as follows:

$${W}_{k}^{( q )} = \{ \begin{matrix}{F}_{\frac{k}{L}}^{( q ) ref} , & if k / L is integer \\ 0 , & otherwise\end{matrix}$$

In some embodiments, for Low-pass filtering, the output of L-fold up-sampling (W) is filtered by an ideal low-pass filter via a convolution operation (or equivalently a multiplication for Fourier transform of W) as follows:

$${E}_{k}^{( q )} = convolution ( W , 2 {f}_{c} sin c ( 2 {f}_{c} k ) ) \\ where {f}_{c} = min ( \frac{1}{2 L} , \frac{1}{2 G} ) .$$

In some embodiments, for G-fold down-sampling, the number of samples are reduced from LN_{sc}_{_{ref}} to N_{sc} by discarding G−1 samples for every G samples in the original sequence,

$${F}_{k}^{( q )} = {E}_{Gk}^{( q )} for k = 1 , … , {N}_{sc} .$$

For example, if N_{sc}_{_{ref}}=330, N_{sc}=240 is utilized, based on

$$\frac{{N}_{sc}}{{N}_{{sc}_{ref}}} = \frac{L}{G} ,$$

L=8 and G=11. First Fₖ^{ref}, k=1, . . . , N_{sc}_{_{ref}}=330, is up sampled by 8, resulting in 2640 samples. After convolution with an ideal low pass filter where

$${f}_{c} = \frac{1}{22} ,$$

the resultant samples are down sampled by 11 and become 240 samples corresponding to the target FDSS taps for taps.

In some embodiments, time domain filter taps h^{(q)}=[h₀^{(q)}, . . . , h_{Z-1}^{(q)}] q=1, . . . , Q (where Z is the number of time domain taps) can be specified in a standard for the q^{th} stream. In some embodiments, for a total subcarrier allocation of N_{sc}, N_{sc} frequency domain filter taps F₁^{(q)}, . . . , F_{N}_{_{SC}}^{(q)} can be calculated based on Fourier transform as follows:

$${F}_{k + 1}^{( q )} = {\sum }_{z = 0}^{Z - 1} {h}_{z}^{( q )} {e}^{- j \frac{2 π}{{N}_{SC}} kz} , 0 \leq k \leq {N}_{SC} - 1.$$

With this approach, a UE or BS can calculate complete frequency domain FDSS filter taps based on the number of subcarriers directly from the Fourier transform.

As Double-FDSS-DFT-s-OFDM is a subset of Multi-FDSS-DFT-s-OFDM, Multi-FDSS-DFT-s-OFDM is utilized in the following examples.

In some embodiments, different pulse shaping filters using mathematical functions such as cosine functions, exponential functions, or hyperbolic functions can be used for Multi-FDSS-DFT-s-OFDM with or without spectral extension. In some embodiments, artificial intelligence (AI)-based techniques or numerical approaches cand be utilized to obtain the FDSS filter tap values per stream with the objective of minimizing a loss function (e.g., to lower SER and PAPR) for a given spectral extension ratio.

In some embodiments, standard may specify FDSS filter taps in one or more of the following ways:
Closed form equations (e.g., root raised cosine, exponential, hyperbolic or polynomial coefficients, etc.)
Poly-Filter: Polynomial coefficients could be utilized to calculate FDSS taps
FD-Filter: Frequency domain (FD) tap values of FDSS (for a reference number of subcarriers) could be utilized to calculate the FDSS taps with an arbitrary subcarrier number
TD-Filter: when time domain (TD) tap values of FDSS are specified in a standard

In some embodiments, a UE or BS may perform some additional procedures to extract and adapt the exact frequency domain tap values for each of the abovementioned approaches, based on the number of allocated/scheduled RBs.

In some embodiments, a feasible range of spectral extension (SE) ratio is dependent on number of scheduled resource blocks (RBs) (or a number of subcarriers). Depending on the number of scheduled RBs, different spectrum extension ratios (SE) could be achieved. In some embodiments, a value “SEIndex” can be defined as an index from 0 to (V−1) indicating a corresponding SE ratio for a given number of RBs (i) or a number of subcarriers (N_{sc}=12 i). The value “SEIndex” (referred to herein as SE_{I}) for different numbers of scheduled subcarriers (N_{sc}) may indicate a different SE ratio (SE). In some embodiments, to support V number of different SE ratios, log₂(V) bits are used to signal a UE (e.g., through RRC or DCI or MAC-CE). For example, in one embodiment, three-bit fields can be allocated for “SEIndex” to indicate a maximum V=8 different SE ratios for a given number of scheduled subcarriers with range of 0≤SE_{I}≤V−1=7). In some embodiments, a look-up table can be defined and specified to map “SEIndex” (SE_{I}) to an SE ratio (SE). For example, a row index of the table may represent “SEIndex” and a column index of the table may refer to number of RBs, where each entry shows the SE ratio corresponding to i and SE_{I}.

In some embodiments, a value “FDSSTypeIndex” can be defined per stream as an index from 0 to (T−1) indicating specific FDSS filters to be utilized for specific stream of Multi-FDSS-DFT-s-OFDM. In some embodiments, to support T number of different FDSS types, H=log₂(T) bits are used to signal a UE (e.g., through RRC or DCI or MAC-CE). For example, a three-bit field can be allocated for “FDSSTypeIndex” to indicate maximum T=8 different filter shapes per stream with range of 0≤T_{I}≤T−1=7) for π/2 BPSK where Q=2. Such an example would use 6 bits for two “FDSSTypeIndex” to support both streams. For an example, T_{I}=1 could refer to root raised cosine, T_{I}=2 could refer to the proposed double FDSS filter (discussed earlier herein), and T_{I}=3 may refer to a specific TD filter and etc.

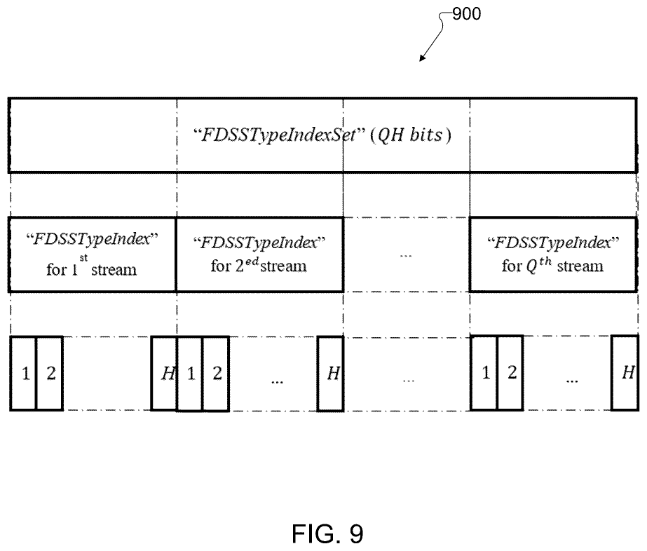

In some embodiments, a total of Q “FDSSTypeIndex”, (for Q streams q=1, . . . , Q) can be grouped into a single field “FDSSTypeIndexSet” with a length of Q H. As shown in FIG. 9.

FIG. 9 illustrates an example structure for “FDSSTypeIndexSet” 900 according to embodiments of the present disclosure. The embodiment of a structure for “FDSSTypeIndexSet” of FIG. 9 is for illustration only. Different embodiments of a structure for “FDSSTypeIndexSet” could be used without departing from the scope of this disclosure.

Although FIG. 9 illustrates an example structure for “FDSSTypeIndexSet” 900, various changes may be made to FIG. 9. For example, various changes to number of streams could be made, etc. according to particular needs.

In some embodiments, the signaling overhead of “FDSSTypeIndexSet” with a length of QH can be reduced to single “FDSSTypeIndex” with length of H. In this manner, “FDSSGroupIndex” could be defined as an index from 0 to (S−1) indicating a group of FDSS filters to be utilized for Q streams of Multi-FDSS-DFT-s-OFDM. In some embodiments, to support S number of groups of FDSS types, H=log₂(S) bits are used to signal the UE (e.g., through RRC or DCI or MAC-CE). Embodiments such as these specifically efficient for scenarios where F^{(q)}, ∀q∈{1, . . . , Q} are dependent on each other and by knowing one of the FDSS shapes per stream, the other (Q−1) filters could be calculated. An example of such an embodiment is given for double FDSS (π/2 BPSK) and Multi FDSS (QPSK) as discussed herein regarding Equation 2 and Equation 3.

In some embodiments, for configuring/reconfiguring of FDSS by the network (NW), The network may provide the UE “FDSSTypeIndex” per stream (or in other embodiments “FDSSGroupIndex”) and “SEIndex” (where the spectral extension index is the same for all Q streams). In some embodiments, the NW explicitly signals the UE for both “FDSSTypeIndexSet” (or “FDSSGroupIndex”) and “SEIndex”. For example, if a three-bit length “FDSSTypeIndex” per stream and three-bit length “SEIndex” are utilized, 8 different FDSS type/shape and 8 different SE ratio could be supported, with a total number of 64 combinations.

In some embodiments, the number of streams (i.e., Q) per modulation scheme can be specified according to a standard. For example, for π/2 BPSK and QPSK, Q can be specified as 2 and 4, respectively.

In some embodiments, time domain filter taps h^{(q)}=[h₀^{(q)}, . . . , h_{Z-1}^{(q)}] (where Z is number of time domain taps) can be mapped to “FDSSTypeIndex” 4 and specific spectral extension ratio 1/2 (mapped to “SEIndex”), where the UE can calculate N_{sc} frequency domain filter taps for q^{th} stream based on a Fourier transform as follows,

$${F}_{k + 1}^{( q )} = {\sum }_{z = 0}^{Z - 1} {h}_{z}^{( q )} {e}^{- j \frac{2 π}{{N}_{SC}} kz} , 0 \leq k \leq {N}_{SC} - 1.$$

In some embodiments, when a Multi-FDSS-DFT-s-OFDM is enabled for the UE to transmit a transport block on a PUSCH or PUCCH, the “FDSSTypeIndexSet” (or “FDSSGroupIndex”) and “SEIndex” provide the UE adequate information on the FDSS shape/type per stream and “SEIndex”. Then, based on number of scheduled RBs and corresponding SEIndex, the UE can determine the exact SE ratio and FDSS tap values for the reference filter. In some embodiments, by default, a rectangular FDSS with zero percent SE ratio is utilized (i.e., “FDSSTypeIndexSet” [or equivalently, “FDSSGroupIndex” ] equals zero and “SEIndex” equals zero).

In some embodiments, for the NW to determine whether a target UE supports Multi-FDSS-DFT-s-OFDM, a UE may compile and transfer its UE capability information upon receiving a UECapabilityEnquiry from a BS. In some embodiments, the UE sets the contents of a UECapabilityInformation message to reflect support for Multi-FDSS-DFT-s-OFDM. In some embodiments, to support Multi-FDSS-DFT-s-OFDM, signaling between a BS and a UE can be based on higher layer radio resource control (RRC) messages or downlink control information (DCI) in Physical Downlink Control Channel (PDCCH) messages or a MAC Control Element (MAC-CE).

In some embodiments, where UEs within a specific UE category support Multi-FDSS-DFT-s-OFDM by default, the NW may determine that the UE supports Multi-FDSS-DFT-s-OFDM without a the UE capability exchange on FDSS between the UE and NW. In such embodiments, whenever DFT-S-OFDM is enabled, FDSSs can be configured by the NW with appropriate fields.

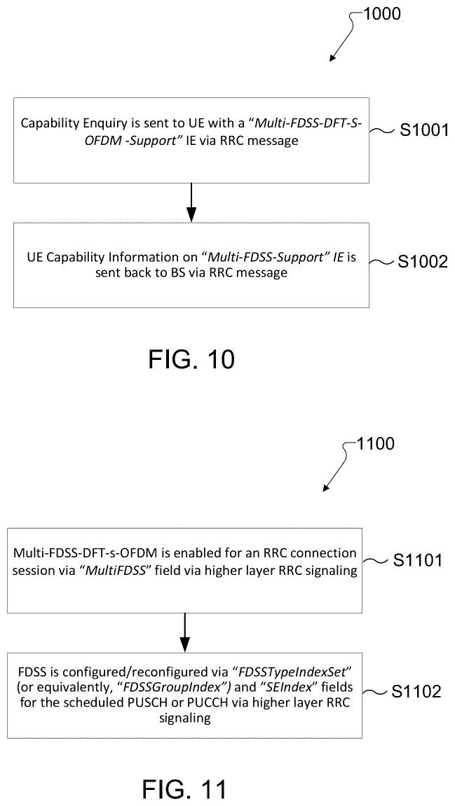

FIG. 10 illustrates an example method for signaling UE capability support 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for signaling UE capability support could be used without departing from the scope of this disclosure.

In the example of FIG. 10, a UE signals capability support of Multi FDSS based on DFT-s-OFDM via RRC. Method 1000 begins at signaling operation S1001. At signaling operation S1001, a BS (e.g., BS 102) inquires whether Multi FDSS with spectral extension is supported by sending a “Multi-FDSS-DFT-S-OFDM-Support” information element (IE) field to a UE (e.g., UE 116). In response at S1002, the UE responds with a “Multi-FDSS-Support” field to indicate whether the UE is supports Multi FDSS with spectral extension.

Although FIG. 10 illustrates one example method for signaling UE capability support 1000, various changes may be made to FIG. 10. For example, while shown as a series of steps, various steps in FIG. 10 could overlap, occur in parallel, occur in a different order, occur any number of times, be omitted, or replaced by other steps.

In some embodiments, an FDSS Selector can be defined as functionality in the MAC layer or in an uplink scheduler or as a separate entity in the radio access network, where “SEIndex” and “FDSSTypeIndexSet” (or equivalently, “FDSSGroupIndex”) are selected for each transmission time interval dynamically by the BS, and the information is signaled to the target UEs. In some other embodiments, semi-dynamic or static/semi-static FDSS decisions can be signaled in advance to reduce the control-signaling overhead. In some embodiments, the FDSS selector and uplink scheduler can configure which UEs to utilize which FDSS filters and, for each of these UEs, the set of resource blocks upon which the UE's uplink data should be transmitted using the specific FDSS filter and SE ratio.

In some embodiments, the FDSS selector may consider some feedback from the UE for selecting an FDSS. For example, the FDSS selector may consider one or more of the following feedback information types from the UE may be used to select “SEIndex” and “FDSSTypeIndexSet” (or equivalently, “FDSSGroupIndex”): CSI, location of the UE, mobility, UE category, buffer status, power headroom reports, transport format selection (selection of transport-block size, modulation scheme, and antenna mapping). In some embodiments, the FDSS selection decisions are made per UE. In some other embodiments, the FDSS selection decisions may be made for a group of UE's (for example, when the group of UEs have similar channel conditions, mobility patterns, power requirements etc.).

In some embodiments, and uplink scheduler and FDSS selector may jointly control the data rate and the PAPR (or other characteristics of the uplink signal) by scheduling and FDSS selection decisions.

In some embodiments, once UE Capability Information is exchanged, and Multi-FDSS-DFT-s-OFDM is enabled by higher layer RRC, the “SEIndex” and “FDSSTypeIndexSet” (or equivalently, “FDSSGroupIndex”) can be configured/reconfigured according to one or more of the following:
Static/semi-Static RRC Configuration of Multi FDSS
Semi-Dynamic Configuration of Multi FDSS (via MAC-CE; for example: a subset of multi FDSS configuration received via RRC may be activated by MAC-CE)
Dynamic Configuration of Multi FDSS (via DCI in PDCCH messages; for example: a particular multi FDSS configuration among the activated configurations may be signaled via DCI)

Once the UE is configured according to one of the above examples, the UE's uplink data should be transmitted using the specific configured FDSS filter and SE ratio for the upcoming PUCCH/PUSCH transmissions.

In some embodiments, “SEIndex” and “FDSSTypeIndexSet” (or equivalently, “FDSSGroupIndex”) can be configured for the UE via RRC by the BS. For example, a configured UE may initiate an uplink transmission with a corresponding FDSS shape per stream and SE ratio. Simultaneously, the BS may utilize the corresponding FDSS shapes and SE ratio at reception. In some embodiments, the Information Element (IE) PUSCH/PUCCH-Config can be applied to enable/disable and configure/reconfigure the UE with specific a FDSS configuration.

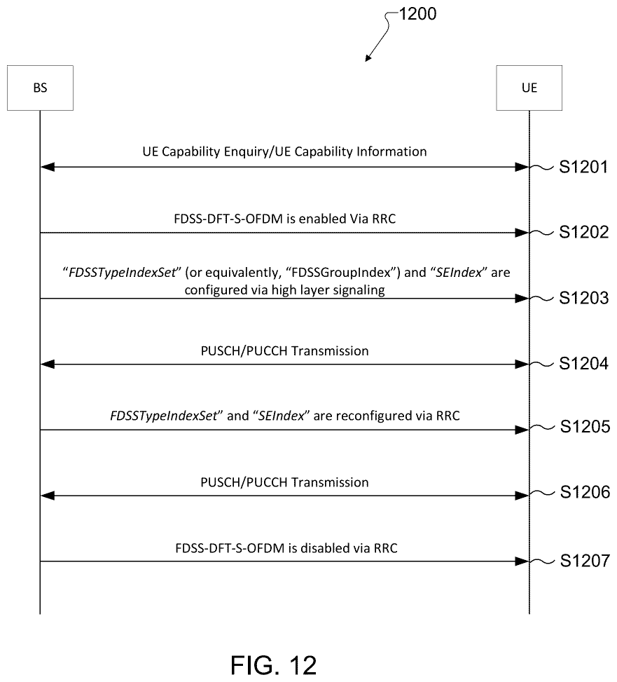

In some embodiments, once FDSS is enabled and configured via RRC, the UE performs frequency domain filtering over PUSCH or PUCCH based on constructed FDSS filter taps and SE ratio. FIG. 11 and FIG. 12 show example signaling exchanges to configure/reconfigure “SEIndex” and “FDSSTypeIndexSet” (or equivalently, “FDSSGroupIndex”). In the examples of FIG. 11 and FIG. 12, Multi-FDSS-DFT-s-OFDM is enabled/disabled using a single bit “MultiFDSS” field.

FIG. 11 illustrates an example method for FDSS configuration 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for FDSS configuration could be used without departing from the scope of this disclosure.

Method 1100 begins at signaling operation S1101. At signaling operation S1101, a BS (e.g., BS 102) enables (or disables) FDSS by enabling a single bit “MultiFDSS” field for a specific UE (e.g., UE 116) in the uplink direction via higher layer RRC messages (e.g., PUSCH/PUCCH-config). Once the FDSS is enabled, at signaling operation S1102, “SEIndex” and “FDSSTypeIndexSef” (or equivalently, “FDSSGroupIndex”) are configured by the BS using corresponding fields in a PUSCH/PUCCH-config RRC message. The UE utilizes the configured/reconfigured FDSS parameters for the upcoming uplink transmission. Optionally, in some embodiments, Multi-FDSS may be disabled via RRC, and may fall back to DFT-s-OFDM without FDSS transmission. In other embodiments, configuration/reconfiguration is performed via DCI in PDCCH messages and/or via MAC-CE.

Although FIG. 11 illustrates one example method for FDSS configuration 1100, various changes may be made to FIG. 11. For example, while shown as a series of steps, various steps in FIG. 11 could overlap, occur in parallel, occur in a different order, occur any number of times, be omitted, or replaced by other steps.

In some embodiments, as shown in in FIG. 12, FDSS-DFT-s-OFDM may be disabled or may be configured to fall back to a default configuration.

FIG. 12 illustrates another example method for FDSS configuration 1200 according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method for FDSS configuration could be used without departing from the scope of this disclosure.

Method 1200 begins at signaling operation S1201. At signaling operation S1201, a BS (e.g., BS 102) exchanges capability information with a UE (e.g., UE 116) regarding support for Multi-FDSS-DFT-s-OFDM. For example, the BS may transmit a capability inquiry to the UE, and the UE may respond with capability information reflecting support for Multi-FDSS-DFT-s-OFDM.

At signaling operation S1202, a BS (e.g., BS 102) enables FDSS-DFT-s-OFDM for the UE via RRC. For example, the BS may transmit an RRC message including a single bit “MultiFDSS” field for the UE in the uplink direction via higher layer RRC messages (e.g., PUSCH/PUCCH-config).

At signaling operation S1203, “SEIndex” and “FDSSTypeIndexSet” (or equivalently, “FDSSGroupIndex”) are configured by the BS using higher layer signaling. For example, the BS may utilize corresponding fields in a PUSCH/PUCCH-config RRC message.

At signaling operation S1204, the UE utilizes the configured FDSS parameters for the upcoming uplink transmission.

At signaling operation S1205, the “SEIndex” and “FDSSTypeIndexSet” (or equivalently, “FDSSGroupIndex”) are reconfigured by the BS using an RRC message. The reconfiguration may be similar as described regarding the configuration at signaling operation S1203.

At signaling operation S1206, reconfigured FDSS parameters for the upcoming uplink transmission.

At step 1207, the BS disables Multi-FDSS for the UE via RRC. In some embodiments, the UE may fall back to DFT-s-OFDM without FDSS transmission.

Although FIG. 12 illustrates one example method for FDSS configuration 1200, various changes may be made to FIG. 12. For example, while shown as a series of steps, various steps in FIG. 12 could overlap, occur in parallel, occur in a different order, occur any number of times, be omitted, or replaced by other steps.

In some embodiments, a MAC-CE can be identified with reserved values in the Logical Channel ID (LCID) field, where the LCID value indicates the “FDSSTypeIndexSet” (or equivalently, “FDSSGroupIndex”) and “SEIndex”. In some embodiments, the MAC-CE can be fixed length. In some other embodiments, the MAC-CE can be variable-length MAC-CE.

In some embodiments, a new MAC-CE “FDSSTypeIndexSet” (or equivalently, “FDSSGroupIndex”) and “SEIndex” capability can be identified by a MAC PDU sub-header with a new LCID with a fixed size of 8 or 16 bits in a PUSCH. In some embodiments, the MAC-CE can be sent by the BS to configure/reconfigure “FDSSTypeIndexSet” (or equivalently, “FDSSGroupIndex”) and “SEIndex”.

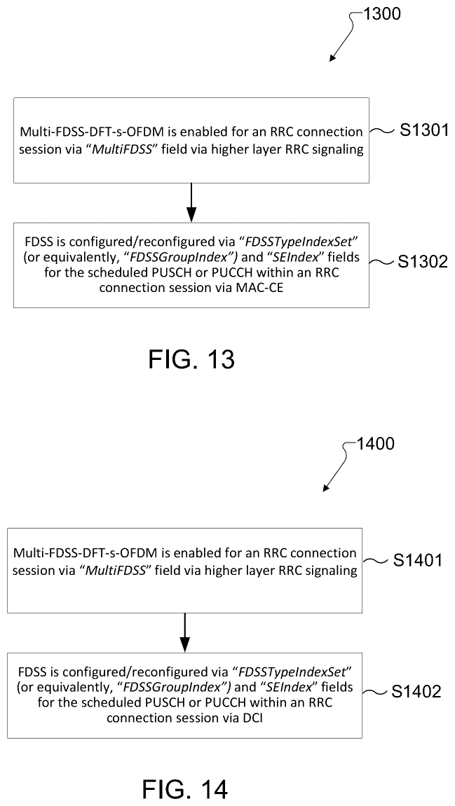

FIG. 13 illustrates an example method for MAC-CE FDSS configuration 1300 according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for MAC-CE FDSS configuration could be used without departing from the scope of this disclosure.

Method 1300 begins at signaling operation S1301. At signaling operation S1301, Multi-FDSS is enabled (e.g., by a BS such as BS 102) by enabling a single bit “MultiFDSS” field for a specific UE (e.g., UE 116) in the uplink direction via higher layer RRC messages (e.g., PUSCH/PUCCH-config).

At signaling operation 1302, “FDSSTypeIndexSet” and “SEIndex” are configured/reconfigured (e.g., by the BS) for the UE via a MAC-CE.

Although FIG. 13 illustrates one example method for MAC-CE FDSS configuration 1300, various changes may be made to FIG. 13. For example, while shown as a series of steps, various steps in FIG. 13 could overlap, occur in parallel, occur in a different order, occur any number of times, be omitted, or replaced by other steps.

Under existing wireless standards, the UE determines the resource block assignment for uplink in the frequency domain using the resource allocation field of DCI (except for Msg.3 PUSCH initial transmission). In the current 5G standard, three uplink resource allocations (type 0, type 1 and type 2) are defined where resource allocation type 0 is used for PUSCH transmission and transform precoding is disabled. The uplink resource allocation type 1 is used for PUSCH transmission regardless of whether transform precoding is enabled or disabled. In some embodiments, when the scheduling PDCCH is received with allocation type 0, the UE can assume that Multi-FDSS-DFT-s-OFDM is disabled.

In some embodiments, the UE can assume that when PDCCH is received with DCI format 0_0, then uplink resource allocation type 1 is utilized where the resource block assignment information informs the UE of a set of contiguously allocated resources. In such cases, Multi-FDSS-DFT-s-OFDM could be enabled.

In some embodiments, the message transmitted via DCI on a PDCCH is utilized to inform a UE in an RRC_CONNECTED state about FDSS-type and SE ratio. In some embodiments, if the UE receives a DCI with “FDSSTypeIndexSet” and “SEIndex”, this informs the UE that the FDSS shall be changed at the next PUSCH/PUCCH based on FDSS shape and SE ratio.

FIG. 14 illustrates an example method for Double-Multi-FDSS configuration via DCI in PDCCH 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for Double-Multi-FDSS configuration via DCI in PDCCH could be used without departing from the scope of this disclosure.

Method 1400 begins at signaling operation S1401. At signaling operation S1401, a BS (e.g., BS 102) can either enable or disable FDSS with spectral extension by enabling a single bit “MultiFDSS” field for a specific UE in the uplink direction using higher layer RRC messages (e.g., PUSCH/PUCCH-config).

At signaling operation S1402, the BS configures/reconfigures FDSS via new “FDSSTypeIndexSet” and “SEIndex” fields for the scheduled PUSCH or PUCCH, enabling dynamic switching between different FDSS shapes and SE ratios within an RRC connection session using DCI formats such as DCI_0_0/DCI_0_1.

Although FIG. 14 illustrates one example method for signaling operation for Double-Multi-FDSS configuration via DCI in PDCCH 1400, various changes may be made to FIG. 14. For example, while shown as a series of steps, various steps in FIG. 14 could overlap, occur in parallel, occur in a different order, occur any number of times, be omitted, or replaced by other steps.

In some embodiments, once UE Capability Information is exchanged, and Multi-FDSS-DFT-s-OFDM is enabled by higher layer RRC, the “SEIndex” and “FDSSTypeIndexSet” (or equivalently, “FDSSGroupIndex”) can be configured/reconfigured via a MAC-CE in a semi-dynamic manner. For example, Multi-FDSS-DFT-s-OFDM can be activated/deactivated dynamically via DCI through a single bit “MultiFDSS”. In these embodiments, once the parameters are configured/reconfigured, the UE may still use current parameters of FDSS. However, once FDSS-DFT-s-OFDM it is activated via DCI, the UE utilizes the configured/reconfigured FDSS parameters for uplink transmission.

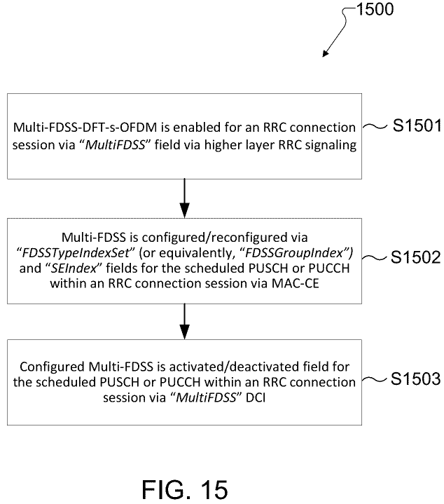

FIG. 15 illustrates another example method for FDSS configuration 1500 according to embodiments of the present disclosure. An embodiment of the signaling operation illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for FDSS configuration could be used without departing from the scope of this disclosure.

Method 1500 begins at signaling operation S1501. At signaling operation S1501, the Multi-FDSS is enabled (e.g., by a BS such as BS 102) by enabling a single bit “MultiFDSS” field for a specific UE (e.g., UE 116) in the uplink direction via higher layer RRC messages (e.g., PUSCH/PUCCH-config).

At signaling operation S1502, “FDSSTypeIndexSet” (or equivalently, “FDSSGroupIndex”) and “SEIndex” are configured/reconfigured (e.g., by the BS) via a MAC-CE.

At signaling operation S1503, the configured Multi-FDSS is activated or deactivated (e.g., by the BS) for the scheduled PUSCH or PUCCH within an RRC connection session via a “MultiFDSS” DCI.

Although FIG. 15 illustrates one example method for FDSS configuration 1500, various changes may be made to FIG. 15. For example, while shown as a series of steps, various steps in FIG. 15 could overlap, occur in parallel, occur in a different order, occur any number of times, be omitted, or replaced by other steps.

In some embodiments, the NW can optionally disable Double/Multi-FDSS-DFT-s-OFDM via a “MultiFDSS” field which is sent to the UE using higher layer signaling such as a PUSCH/PUCCH-config RRC message. In some embodiments, the NW can optionally disable Double/Multi-FDSS-DFT-s-OFDM by setting “FDSSTypeIndexSet” (or equivalently, “FDSSGroupIndex”) corresponding to rectangular and “SEIndex” to zero.

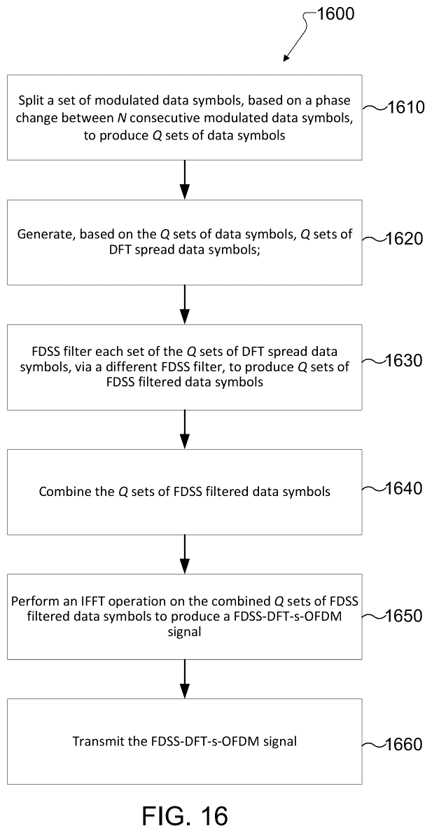

FIG. 16 illustrates an example method for spectral shaping for DFT-s-OFDM 1600 according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of a method for spectral shaping for DFT-s-OFDM could be used without departing from the scope of this disclosure.

In the example of FIG. 16, method 1600 begins at step 1610, at step 1610, an apparatus such as UE 116 or BS 102 of FIG. 1 splits a set of modulated data symbols, based on a phase change between N consecutive modulated data symbols, to produce Q sets of data symbols.

In some embodiments the set of modulated data symbols may be π/2 binary phase-shift keying (BPSK) modulated, N=2, and Q=2. In some embodiments, to produce the Q sets of data symbols, the transceiver is further configured to split the set of modulated data symbols to produce a −π/2 phase-change set and a +π/2 phase-change set.

In some embodiments, the set of modulated data symbols quadrature phase-shift keying (QPSK) modulated, Q=4, and N=2.

At step 1620, the apparatus generates, based on the Q sets of data symbols, Q sets of DFT spread data symbols.

In some embodiments, to generate, based on the Q sets of data symbols, Q sets of DFT spread data symbols, the apparatus may: multiply elements of the −π/2 phase-change set by j, and add the resulting elements to corresponding elements of the +π/2 phase-change set to produce a set of combined symbols; perform DFT spreading on the set of combined symbols to produce a set of DFT spread output symbols; halve a sum of the DFT spread output symbols and a conjugate of shifted DFT spread output symbols to produce a first set of DFT spread data symbols; and multiply by −j/2 a difference between the DFT spread output symbols and the conjugate of the shifted DFT spread output symbols to produce a second set of DFT spread data symbols. In some embodiments, the Q sets of DFT spread data symbols comprises the first and second set of DFT spread data symbols.

At step 1630, the apparatus FDSS filters each set of the Q sets of DFT spread data symbols, via a different FDSS filter, to produce Q sets of FDSS filtered data symbols.

In some embodiments, to FDSS filter each set of the Q sets of DFT spread data symbols, via a different FDSS filter, the apparatus may FDSS filter the first set of DFT spread data symbols via a first FDSS filter, and FDSS filtering the first set of DFT spread data symbols via a second FDSS filter. In some embodiments, the second FDSS filter is a conjugate reversed frequency version of the first FDSS filter.

In some embodiments, before FDSS filtering each set of the Q sets of DFT spread data symbols, the apparatus may add a predefined number of subcarriers to each set of the Q sets of DFT spread data symbols. In some embodiments, the predefined number of subcarriers is equal for each set of the Q sets of DFT spread data symbols, and a total number of subcarriers added to the Q sets of DFT spread data symbols is used as a length of the IFFT operation.

In some embodiments, to generate, based on the Q sets of data symbols, Q sets of DFT spread data symbols, the apparatus may DFT spread the Q sets of data symbols to produce Q sets of DFT spread data symbols.

At step 1640, the apparatus combines the Q sets of FDSS filtered data symbols.

At step 1650, the apparatus performs an IFFT operation on the combined Q sets of FDSS filtered data symbols to produce a FDSS-DFT-s-OFDM signal.

Finally, at step 1660, the apparatus transmits the FDSS-DFT-s-OFDM signal.

Although FIG. 16 illustrates one example method for spectral shaping for DFT-s-OFDM 1600, various changes may be made to FIG. 16. For example, while shown as a series of steps, various steps in FIG. 16 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An apparatus comprising:
a processor; and
a transceiver operatively coupled to the processor, the transceiver configured to:
split a set of modulated data symbols, based on a phase change between N consecutive modulated data symbols, to produce Q sets of data symbols;
generate, based on the Q sets of data symbols, Q sets of DFT spread data symbols;
frequency domain spectrum shaping (FDSS) filter each set of the Q sets of DFT spread data symbols, via a different FDSS filter, to produce Q sets of FDSS filtered data symbols;
combine the Q sets of FDSS filtered data symbols;
perform an inverse fast Fourier transform (IFFT) operation on the combined Q sets of FDSS filtered data symbols to produce a FDSS-discrete Fourier transform-spread-orthogonal frequency division multiplexing (DFT-s-OFDM) signal; and
transmit the FDSS-DFT-s-OFDM signal.

2. The apparatus of claim 1, wherein:
the set of modulated data symbols is π/2 binary phase-shift keying (BPSK) modulated;
N=2;
Q=2;
to produce the Q sets of data symbols, the transceiver is further configured to split the set of modulated data symbols to produce a −π/2 phase-change set and a +π/2 phase-change set; and
to generate, based on the Q sets of data symbols, Q sets of DFT spread data symbols, the transceiver is further configured to:
multiply elements of the −π/2 phase-change set by j, and add the resulting elements to corresponding elements of the +π/2 phase-change set to produce a set of combined symbols;
perform DFT spreading on the set of combined symbols to produce a set of DFT spread output symbols;
halve a sum of the DFT spread output symbols and a conjugate of shifted DFT spread output symbols to produce a first set of DFT spread data symbols; and
multiply by −j/2 a difference between the DFT spread output symbols and the conjugate of the shifted DFT spread output symbols to produce a second set of DFT spread data symbols,
wherein the Q sets of DFT spread data symbols comprises the first and second set of DFT spread data symbols.

3. The apparatus of claim 2, wherein to FDSS filter each set of the Q sets of DFT spread data symbols, via a different FDSS filter, the transceiver is further configured to:
FDSS filter the first set of DFT spread data symbols via a first FDSS filter; and
FDSS filter the first set of DFT spread data symbols via a second FDSS filter,
wherein the second FDSS filter is a conjugate reversed frequency version of the first FDSS filter.

4. The apparatus of claim 1, wherein the transceiver is further configured to:
before FDSS filtering each set of the Q sets of DFT spread data symbols, adding a predefined number of subcarriers to each set of the Q sets of DFT spread data symbols.

5. The apparatus of claim 4, wherein:
the predefined number of subcarriers is equal for each set of the Q sets of DFT spread data symbols; and
a total number of subcarriers added to the Q sets of DFT spread data symbols is used as a length of the IFFT operation.

6. The apparatus of claim 1, wherein to generate, based on the Q sets of data symbols, Q sets of DFT spread data symbols, the transceiver is further configured to discrete Fourier transform (DFT) spread the Q sets of data symbols to produce Q sets of DFT spread data symbols.

7. The apparatus of claim 6, wherein:
the set of modulated data symbols quadrature phase-shift keying (QPSK) modulated;
Q=4; and
N=2.

8. A method of operating an apparatus, the method comprising:
splitting a set of modulated data symbols, based on a phase change between N consecutive modulated data symbols, to produce Q sets of data symbols;
generating, based on the Q sets of data symbols, Q sets of DFT spread data symbols;
frequency domain spectrum shaping (FDSS) filtering each set of the Q sets of DFT spread data symbols, via a different FDSS filter, to produce Q sets of FDSS filtered data symbols;
combining the Q sets of FDSS filtered data symbols;
performing an inverse fast Fourier transform (IFFT) operation on the combined Q sets of FDSS filtered data symbols to produce a FDSS-discrete Fourier transform-spread-orthogonal frequency division multiplexing (DFT-s-OFDM) signal; and
transmitting the FDSS-DFT-s-OFDM signal.

9. The method of claim 8, wherein:
the set of modulated data symbols is π/2 binary phase-shift keying (BPSK) modulated;
N=2;
Q=2;
to produce the Q sets of data symbols, the method further comprises splitting the set of modulated data symbols to produce a −π/2 phase-change set and a +π/2 phase-change set; and
to generate, based on the Q sets of data symbols, Q sets of DFT spread data symbols, the method further comprises:
multiplying elements of the −π/2 phase-change set by j, and add the resulting elements to corresponding elements of the +π/2 phase-change set to produce a set of combined symbols;
performing DFT spreading on the set of combined symbols to produce a set of DFT spread output symbols;
halving a sum of the DFT spread output symbols and a conjugate of shifted DFT spread output symbols to produce a first set of DFT spread data symbols; and
multiplying by −j/2 a difference between the DFT spread output symbols and the conjugate of the shifted DFT spread output symbols to produce a second set of DFT spread data symbols,
wherein the Q sets of DFT spread data symbols comprises the first and second set of DFT spread data symbols.

10. The method of claim 9, wherein to FDSS filter each set of the Q sets of DFT spread data symbols, via a different FDSS filter, the method further comprises:
FDSS filtering the first set of DFT spread data symbols via a first FDSS filter; and
FDSS filtering the first set of DFT spread data symbols via a second FDSS filter,
wherein the second FDSS filter is a conjugate reversed frequency version of the first FDSS filter.

11. The method of claim 8, further comprising:
before FDSS filtering each set of the Q sets of DFT spread data symbols, adding a predefined number of subcarriers to each set of the Q sets of DFT spread data symbols.

12. The method of claim 11, wherein:
the predefined number of subcarriers is equal for each set of the Q sets of DFT spread data symbols; and
a total number of subcarriers added to the Q sets of DFT spread data symbols is used as a length of the IFFT operation.

13. The method of claim 8, wherein to generate, based on the Q sets of data symbols, Q sets of DFT spread data symbols, the method further comprises discrete Fourier transform (DFT) spreading the Q sets of data symbols to produce Q sets of DFT spread data symbols.

14. The method of claim 13, wherein:
the set of modulated data symbols quadrature phase-shift keying (QPSK) modulated;
Q=4; and
N=2.

15. A user equipment (UE) comprising:
a processor; and
a transceiver operatively coupled to the processor, the transceiver configured to:
receive a first message enabling a frequency domain spectral shaping (FDSS)-discrete Fourier transform-spread-orthogonal frequency division multiplexing (DFT-s-OFDM) capability of the UE;
receive a second message configuring the FDSS-DFT-s-OFDM capability for an uplink transmission; and
in response to receiving the second message:
split a set of modulated data symbols for the uplink transmission, based on a phase change between N consecutive modulated data symbols, to produce Q sets of data symbols;
generate, based on the Q sets of data symbols, Q sets of DFT spread data symbols;
frequency domain spectrum shaping (FDSS) filter each set of the Q sets of DFT spread data symbols, via a different FDSS filter, to produce Q sets of FDSS filtered data symbols;
combine the Q sets of FDSS filtered data symbols;
perform an inverse fast Fourier transform (IFFT) operation on the combined Q sets of FDSS filtered data symbols to produce a FDSS-DFT-s-OFDM signal; and
transmit the FDSS-DFT-s-OFDM signal.

16. The UE of claim 15, wherein the transceiver is further configured to:
before receiving the first message and the second message, receive a third message including information requesting UE capability information; and
transmit a fourth message including information indicating the FDSS-DFT-s-OFDM capability of the UE.

17. The UE of claim 15, wherein the second message indicates, for each set of the Q sets, a specific FDSS filter with which to FDSS filter that set.

18. The UE of claim 15, wherein the second message indicates a group of FDSS filters with which to FDSS filter each set of the Q sets of DFT spread data symbols.

19. The UE of claim 15, wherein:
the set of modulated data symbols is π/2 binary phase-shift keying (BPSK) modulated;
N=2;
Q=2;
to produce the Q sets of data symbols, the transceiver is further configured to split the set of modulated data symbols for the uplink transmission to produce a −π/2 phase-change set and a +π/2 phase-change set; and
to generate, based on the Q sets of data symbols, Q sets of DFT spread data symbols, the transceiver is further configured to:
multiply elements of the −π/2 phase-change set by j, and add the resulting elements to corresponding elements of the +π/2 phase-change set to produce a set of combined symbols;
perform DFT spreading on the set of combined symbols to produce a set of DFT spread output symbols;
halve a sum of the DFT spread output symbols and a conjugate of shifted DFT spread output symbols to produce a first set of DFT spread data symbols; and
multiply by −j/2 a difference between the DFT spread output symbols and the conjugate of the shifted DFT spread output symbols to produce a second set of DFT spread data symbols,
wherein the Q sets of DFT spread data symbols comprises the first and second set of DFT spread data symbols.

20. The UE of claim 15, wherein to generate, based on the Q sets of data symbols, Q sets of DFT spread data symbols, the transceiver is further configured to discrete Fourier transform (DFT) spread the Q sets of data symbols to produce Q sets of DFT spread data symbols.
